(19) United States
(12) Patent Application Publication
(10) Pub. No.: US 2019/0121727 A1
(43) Pub. Date: Apr. 25, 2019

(54) MEMORY SYSTEM AND METHOD FOR OPERATING THE SAME

(71) Applicant: SK hynix Inc., Gyeonggi-do (KR)

(72) Inventors: Young Ho KIM, Gyeonggi-do (KR); Seung Geol BAEK, Gyeonggi-do (KR); Suk Ho JUNG, Gyeonggi-do (KR); Yong JIN, Seoul (KR)

(21) Appl. No.: 15/995,883

(22) Filed: Jun. 1, 2018

(30) Foreign Application Priority Data
Oct. 19, 2017 (KR) 10-2017-0135902

(51) Int. Cl. G06F 12/02

(52) U.S. Cl. CPC G06F 12/0246; G06F 12/0253

(57) ABSTRACT

Provided herein may be a memory system and a method for operating the memory system. The memory system includes: memory devices including memory blocks; a super block configured of the memory blocks; and a memory controller coupled to the memory devices. The memory controller includes: a host write control section configured to control the memory devices such that a program operation is performed in parallel on the memory blocks included in the super block; a valid page information management section configured to store valid page information of each of the memory blocks; and a garbage collection control section configured to select at least one of the memory blocks as a victim block based on the valid page information and perform a garbage collection operation on the victim block.

### CROSS-REFERENCE TO RELATED APPLICATION

The present application claims priority under 35 U.S.C. § 119(a) to Korean patent application number 10-2017-0135902, filed on Oct. 19, 2017, which is incorporated herein by reference in its entirety.

### BACKGROUND

### 1. Field of Invention

Various embodiments of the present disclosure generally relate to a memory system and a method for operating the memory system, and more particularly, a memory system configured to perform a garbage collection operation based on valid page information of a plurality of memory blocks included in a super block, and a method of operating the memory system.

### 2. Description of the Related Art

A memory device may include a plurality of memory blocks. Each memory block may include a plurality of memory cells. The memory cells included in each memory block may be simultaneously erased.

A memory system may include a plurality of memory devices. In the memory system, a plurality of memory blocks included in the plurality of memory devices may be divided into a plurality of super blocks each including two or more memory blocks. Management on a super block basis makes it possible for the memory system to more efficiently control the plurality of memory blocks.

The memory system may secure a free block through a garbage collection operation. The garbage collection operation may be an operation which secures free blocks by copying valid pages of memory blocks to another memory block and performing an erase operation on the memory blocks.

### SUMMARY

Various embodiments of the present disclosure are directed to a memory system capable of efficiently performing a garbage collection operation, and a method for operating the memory system.

An embodiment of the present disclosure may provide for a memory system including: memory devices including memory blocks; a super block configured of the memory blocks; and a memory controller coupled to the memory devices. The memory controller may include: a host write control section configured to control the memory devices such that a program operation is performed in parallel on the memory blocks included in the super block; a valid page information management section configured to store valid page information of each of the memory blocks; and a garbage collection control section configured to select at least one of the memory blocks as a victim block based on the valid page information and perform a garbage collection operation on the victim block.

An embodiment of the present disclosure may provide for a method for operating a memory system, including: selecting a victim block among erase unit blocks included in a first super block; copy-programming data stored in valid pages included in the selected victim block to a second super block; and performing an erase operation on the victim block on which the copy-programming has been performed. The selecting of the victim block may be performed based on the number of valid pages of each of the erase unit blocks.

An embodiment of the present disclosure may provide a method for operating a memory system, including: selecting N (N is a natural number of 2 or more) victim blocks among memory blocks included in super blocks; and performing a garbage collection operation on the selected victim blocks. Each of the super blocks may include N memory blocks among the memory blocks. The N memory blocks may be respectively included in N memory devices forming different ways. The selecting of the victim blocks may be performed based on the number of free blocks included in each of the N memory devices.

An embodiment of the present disclosure may provide for a memory system including: a plurality of memory devices including first and second super blocks each having a plurality of erase-unit-blocks; and a memory controller suitable for controlling the memory devices, wherein the memory controller performs: a program operation to pages of the erase-unit-blocks in parallel in the respective super blocks; and performs a garbage collection operation to one or more victim blocks among the erase-unit-blocks in the first super block by copying data of the victim blocks into the second super block.

### BRIEF DESCRIPTION OF THE DRAWINGS

FIG. 1 is a diagram illustrating a memory system in accordance with an embodiment of the present disclosure.

FIG. 2 is a diagram illustrating a memory controller of FIG. 1.

FIG. 3 is a diagram illustrating a memory system in accordance with an embodiment of the present disclosure.

FIG. 4 is a diagram illustrating a nonvolatile memory device in accordance with an embodiment of the present disclosure.

FIG. 5 is a diagram illustrating a memory block in accordance with an embodiment of the present disclosure.

FIG. 6 is a diagram illustrating an example of a memory block having a three-dimensional structure in accordance with an embodiment of the present disclosure.

FIG. 7 is a diagram illustrating an example of a memory block having a three-dimensional structure in accordance with an embodiment of the present disclosure.

FIG. 8 is a diagram illustrating a method for generating a super block in accordance with an embodiment of the present disclosure.

FIG. 9 is a diagram illustrating a method for programming program data to the super block in accordance with an embodiment of the present disclosure.

FIG. 10 is a timing diagram illustrating an operation of programming program data to the super block in accordance with an embodiment of the present disclosure.

FIG. 11 is a diagram illustrating a garbage collection operation in accordance with an embodiment of the present disclosure.

FIG. 12 is a diagram illustrating a garbage collection operation in accordance with an embodiment of the present disclosure.

FIG. 13 is a diagram illustrating a memory controller in accordance with an embodiment of the present disclosure.

FIG. 14 is a diagram illustrating an example of a memory system including the memory controller shown in FIG. 13.

FIG. 15 is a diagram illustrating an example of a memory system including the memory controller shown in FIG. 13.

FIG. 16 is a diagram illustrating an example of a memory system including the memory controller shown in FIG. 13.

FIG. 17 is a diagram illustrating an example of a memory system including the memory controller shown in FIG. 13.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present.

Hereinafter, embodiments will be described with reference to the accompanying drawings. Embodiments are described herein with reference to cross-sectional illustrations that are schematic illustrations of embodiments and intermediate structures. As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as “first” and “second” may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, “and/or” may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

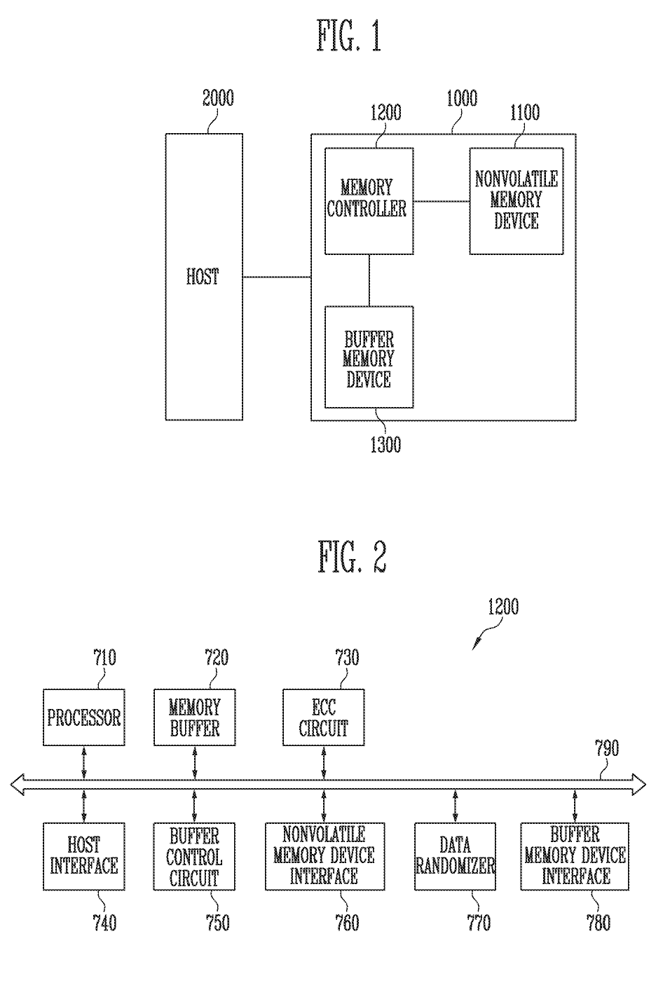

FIG. 1 is a diagram illustrating a memory system 1000 in accordance with an embodiment of the present disclosure.

Referring to FIG. 1, the memory system 1000 may include a nonvolatile memory device 1100 which retains stored data even when power is turned off, a buffer memory device 1300 configured to temporarily store data, and a memory controller 1200 configured to control the nonvolatile memory device 1100 and the buffer memory device 1300 under control of a host 2000.

The host interface 2000 may communicate with the memory system 1000 using at least one of various communication methods such as a universal serial bus (USB), a serial AT attachment (SATA), a serial attached SCSI (SAS), a high speed interchip (HSIC), a small computer system interface (SCSI), a peripheral component interconnection (PCI), a PCI express (PCIe), a nonvolatile memory express (NVMe), a universal flash storage (UFS), a secure digital (SD), multimedia card (MMC), an embedded MMC (eMMC), a dual in-line memory module (DIMM), a registered DIMM (RDIMM), and a load reduced DIMM (LRDIMM).

The memory controller 1200 may control the overall operation of the memory system 1000 and data exchange between the host 2000 and the nonvolatile memory device 1100. For instance, the memory controller 1200 may control the nonvolatile memory device 1100 to program or read data in response to a request of the host 2000. Furthermore, the memory controller 1200 may control the nonvolatile memory device 1100 such that information is stored in main memory blocks and sub-memory blocks included in the nonvolatile memory device 1100, and a program operation is performed on the main memory blocks or the sub-memory blocks depending on the amount of data loaded for the program operation. In an embodiment, the nonvolatile memory device 1100 may include a flash memory.

The memory controller 1200 may control data exchange between the host 2000 and the buffer memory device 1300 or temporarily store system data for controlling the nonvolatile memory device 1100 in the buffer memory device 1300. The buffer memory device 1300 may be used as an operation memory, a cache memory, or a buffer memory of the memory controller 1200. The buffer memory device 1300 may store codes and commands to be executed by the memory controller 1200. The buffer memory device 1300 may store data to be processed by the memory controller 1200.

The memory controller 1200 may temporarily store data input from the host 2000 in the buffer memory device 1300, and then transmit the data temporarily stored in the buffer memory device 1300 to the nonvolatile memory device 1100 and store it therein. Furthermore, the memory controller 1200 may receive data and a logical address from the host 2000 and convert the logical address to a physical address indicating an area in which the data is to be actually stored in the nonvolatile memory device 1100. The memory controller 1200 may store, in the buffer memory device 1300, a logical-to-physical address mapping table indicating a mapping relationship between logical addresses and physical addresses.

In an embodiment, the buffer memory device 1300 may include a double data rate synchronous dynamic random access memory (DDR SDRAM), a DDR4 SDRAM, a low power double data rate4 (LPDDR4) SDRAM, a graphics double data rate (GDDR) SDRAM, a low power DDR (LPDDR), or a rambus dynamic random access memory (RDRAM). In an embodiment, the memory system 1000 may not include the buffer memory device 1300.

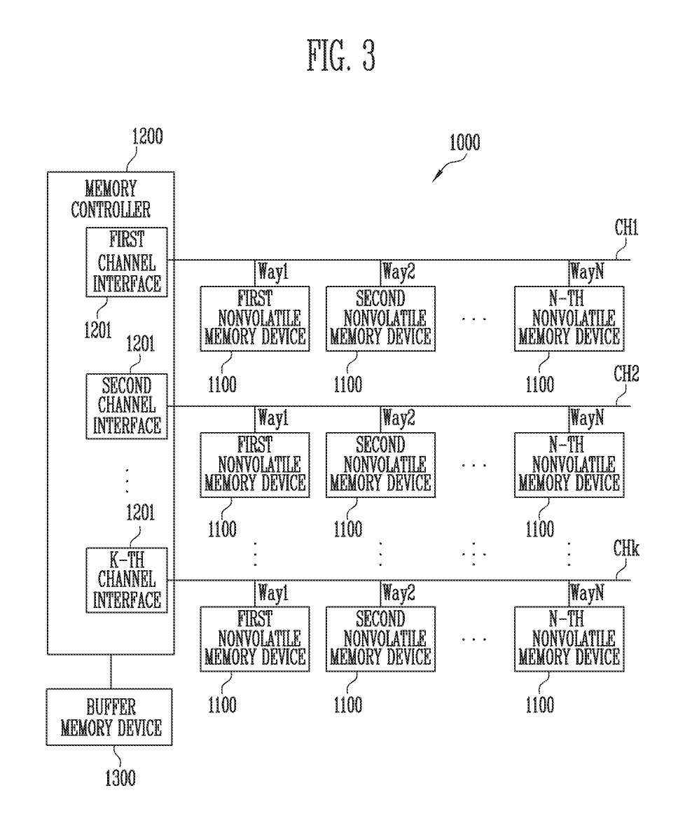

FIG. 2 is a diagram illustrating the memory controller 1200 of FIG. 1.

Referring to FIG. 2, the memory controller 1200 may include a processor 710, a memory buffer 720, an error correction code (ECC) circuit 730, a host interface 740, a buffer control circuit 750, a nonvolatile memory device interface 760, a data randomizer 770, a buffer memory device interface 780, and a bus 790.

The bus 790 may provide a channel between components of the memory controller 1200.

The processor 710 may control the overall operation of the memory controller 1200 and perform a logical operation. The processor 710 may communicate with the external host 2000 through the host interface 740, and communicate with the nonvolatile memory device 1100 through the nonvolatile memory device interface 760. Furthermore, the processor 710 may communicate with the buffer memory device 1300 through the buffer memory device interface 780. The processor 710 may control the memory buffer 720 through the buffer control circuit 750. The processor 710 may use the memory buffer 720 as an operation memory, a cache memory, or a buffer memory to control the operation of the memory system 1000.

The processor 710 may queue a plurality of commands input from the host 2000. This operation is called a multi-queue operation. The processor 710 may sequentially transmit the queued commands to the nonvolatile memory device 1100.

The memory buffer 720 may be used as an operation memory, a cache memory, or a buffer memory of the processor 710. The memory buffer 720 may store codes and commands to be executed by the processor 710. The memory buffer 720 may store data to be processed by the processor 710. The memory buffer 720 may include a static RAM (SRAM) or a dynamic RAM (DRAM).

The ECC circuit 730 may perform error correction. The ECC circuit 730 may perform ECC encoding based on data to be written in the nonvolatile memory device 1100 through the nonvolatile memory device interface 760. ECC encoded data may be transmitted to the nonvolatile memory device 1100 through the nonvolatile memory device interface 760. The ECC circuit 730 may perform ECC decoding for data received from the nonvolatile memory device 1100 through the nonvolatile memory device interface 760. For example, the ECC circuit 730 may be included in the nonvolatile memory device interface 760 as a component of the nonvolatile memory device interface 760.

The host interface 740 may communicate with the external host 2000 under control of the processor 710. The host interface 740 may perform communication using at least one of various communication methods such as a universal serial bus (USB), a serial AT attachment (SATA), a serial attached SCSI (SAS), a high speed interchip (HSIC), a small computer system interface (SCSI), a peripheral component interconnection (PCI), a PCI express (PCIe), a nonvolatile memory express (NVMe), a universal flash storage (UFS), a secure digital (SD), a multimedia card (MMC), an embedded MMC (eMMC), a dual in-line memory module (DIMM), a registered DIMM (RDIMM), and a load reduced DIMM (LRDIMM).

The buffer control circuit 750 may control the memory buffer 720 under control of the processor 710.

The nonvolatile memory device interface 760 may communicate with the nonvolatile memory device 1100 under control of the processor 710. The nonvolatile memory device interface 760 may communicate a command, an address, and data with the nonvolatile memory device 1100 through a channel.

For example, the memory controller 1200 may include neither the memory buffer 720 nor the buffer control circuit 750.

For instance, the processor 710 may use a code to control the operation of the memory controller 1200. The processor 710 may load a code from a nonvolatile memory device (e.g., a read only memory) provided in the memory controller 1200. Alternatively, the processor 710 may load a code from the nonvolatile memory device 1100 through the nonvolatile memory device interface 760.

The data randomizer 770 may randomize data or de-randomize the randomized data. The data randomizer 770 may perform a data randomization operation for data to be written in the nonvolatile memory device 1100 through the nonvolatile memory device interface 760. Randomized data may be transmitted to the nonvolatile memory device 1100 through the nonvolatile memory device interface 760. The data randomizer 770 may perform a data de-randomization operation for data received from the nonvolatile memory device 1100 through the nonvolatile memory device interface 760. For example, the data randomizer 770 may be included in the nonvolatile memory device interface 760 as a component of the nonvolatile memory device interface 760.

For example, the bus 790 of the memory controller 1200 may be divided into a control bus and a data bus. The data bus may transmit data in the memory controller 1200. The control bus may transmit control information such as a command and an address in the memory controller 1200. The data bus and the control bus may be separated from each other and may neither interfere with each other nor affect each other. The data bus may be coupled to the host interface 740, the buffer controller 750, the ECC circuit 730, the nonvolatile memory device interface 760, and the buffer memory device interface 780. The control bus may be coupled to the host interface 740, the processor 710, the buffer control circuit 750, the nonvolatile memory device interface 760, and the buffer memory device interface 780.

The buffer memory device interface 780 may communicate with the buffer memory device 1300 under control of the processor 710. The buffer memory device interface 780 may communicate a command, an address, and data with the buffer memory device 1300 through a channel. For example, the memory controller 1200 may not include the buffer memory device interface 780.

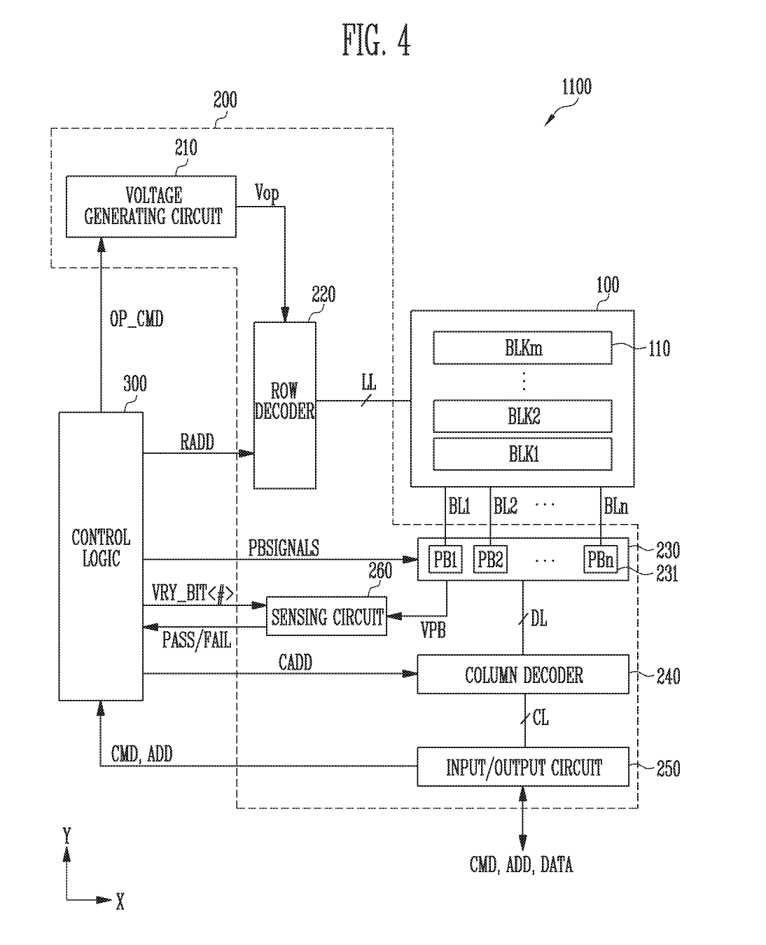

FIG. 3 is a diagram illustrating a memory system 1000 in accordance with an embodiment of the present disclosure. FIG. 3 illustrates the memory system 1000 including a memory controller 1200, and a plurality of nonvolatile memory devices 1100 coupled to the memory controller 1200 through a plurality of channels CH1 to CHk.

Referring to FIG. 3, the memory controller 1200 may communicate with the nonvolatile memory devices 1100 through the channels CH1 to CHk. The memory controller 1200 may include a plurality of channel interfaces 1201. Each of the channels CH1 to CHk may be coupled to a corresponding one of the channel interfaces 1201. For example, the first channel CH1 may be coupled to the first channel interface 1201, the second channel CH2 may be coupled to the second channel interface 121, and the k-th channel CHk may be coupled to the k-th channel interface 1201. Each of the channels CH1 to CHk may be coupled to one or more nonvolatile memory devices 1100. The nonvolatile memory devices 1100 that are coupled to different channels may operate independently from each other. For example, the nonvolatile memory devices 1100 coupled to the first channel CH1 may operate independently from the nonvolatile memory devices 1100 coupled to the second channel CH2. For instance, the memory controller 1200 may communicate data or a command through the first channel CH1 with the nonvolatile memory devices 1100 coupled to the first channel CH1 and, in parallel, communicate data or a command through the second channel CH2 with the nonvolatile memory devices 1100 coupled to the second channel CH2.

Each of the channels CH1 to CHk may be coupled to a plurality of nonvolatile memory devices 1100. The nonvolatile memory devices 1100 coupled to each channel may form respective different ways. For example, N nonvolatile memory devices 1100 may be coupled to each channel, and each nonvolatile memory device 1100 may form a different way. For example, first to N-th nonvolatile memory devices 1100 may be coupled to the first channel CH1. The first nonvolatile memory device 1100 may form a first way Way1, the second nonvolatile memory device 1100 may form a second way Way2, and the N-th nonvolatile memory device 1100 may form an N-th way WayN. Alternatively, unlike the example of FIG. 2, two or more nonvolatile memory devices 1100 may form a single way.

The first to N-th nonvolatile memory devices 1100 coupled to the first channel CH1 may sequentially communicate data or a command with the memory controller 1200, rather than simultaneously communicating in parallel the data or the command with the memory controller 1200 through the first channel CH1, because the first to N-th nonvolatile memory devices 1100 share the first channel CH1. In other words, while the memory controller 1200 sends, through the first channel CH1, data to the first nonvolatile memory device 1100 forming the first way Way1 of the first channel CH1, the second to N-th nonvolatile memory devices 1100 forming the second to N-th ways Way2 to WayN of the first channel CH1 cannot communicate data or a command with the memory controller 1200 through the first channel CH1. In other words, while any one of the first to N-th nonvolatile memory devices 1100 sharing the first channel CH1 occupies the first channel CH1, the other nonvolatile memory devices 1100 coupled to the first channel CH1 cannot occupy the first channel CH1.

The first nonvolatile memory device 1100 forming the first way Way1 of the first channel CH1 and the first nonvolatile memory device 1100 forming the first way Way1 of the second channel CH2 may independently communicate with the memory controller 1200. In other words, while the memory controller 1200 communicates data with the first nonvolatile memory device 1100 forming the first way Way1 of the first channel CH1 through the first channel CH1 and the first channel interface 1201, simultaneously the memory controller 1200 may communicate data with the first nonvolatile memory device 1100 forming the first way Way1 of the second channel CH2 through the second channel CH2 and the second channel interface 1201.

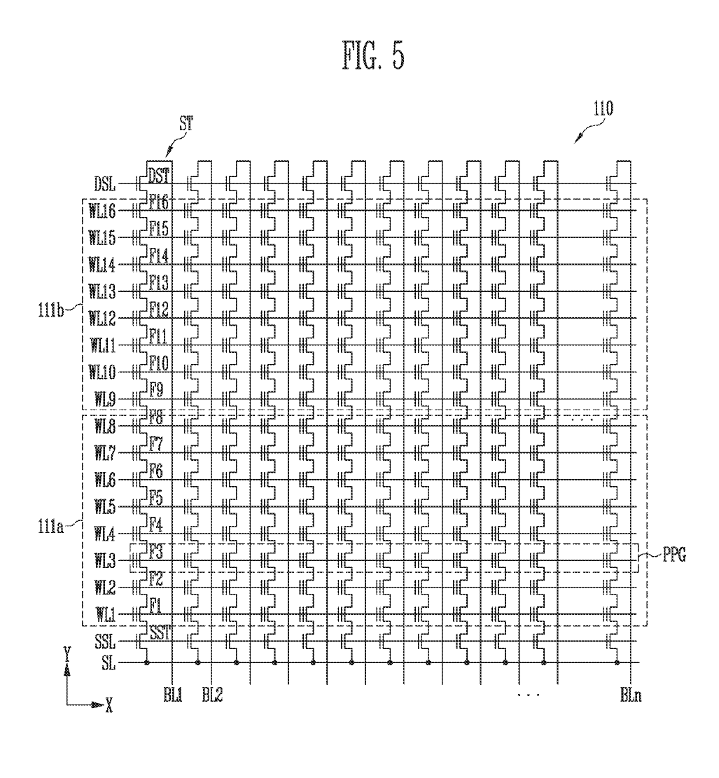

FIG. 4 is a diagram illustrating a nonvolatile memory device 1100 in accordance with an embodiment of the present disclosure.

Referring to FIG. 4, the nonvolatile memory device 1100 may include a memory cell array 100 configured to store data. The nonvolatile memory device 1100 may include peripheral circuits 200 configured to perform a program operation for storing data in the memory cell array 100, a read operation for outputting the stored data, and an erase operation for erasing the stored data. The nonvolatile memory device 1100 may include a control logic 300 configured to control the peripheral circuits 200 under control of the memory controller (1200 of FIG. 1).

The memory cell array 100 may include a plurality of memory blocks BLK1 to BLKm (110), where m is a positive integer. Local lines LL and bit lines BL1 to BLn (where n is a positive integer) may be coupled to each of the memory blocks BLK1 to BLKm (110). For example, the local lines LL may include a first select line, a second select line, and a plurality of word lines arranged between the first and second select lines. Furthermore, the local lines LL may include dummy lines arranged to between the first select line and the word lines, and between the second select line and the word lines. Here, the first select line may be a source select line, and the second select line may be a drain select line. For example, the local lines LL may include word lines, drain select lines, source select lines, and source lines. The local lines LL may further include dummy lines. In addition, the local lines LL may further include pipelines. The local lines LL may be coupled to each of the memory blocks BLK1 to BLKm (110). The bit lines BL1 to BLn may be coupled in common to the memory blocks BLK1 to BLKm (110). The memory blocks BLK1 to BLKm (110) may be embodied in a two- or three-dimensional structure. For example, in the memory blocks 110 having a two-dimensional structure, the memory cells may be arranged in a direction parallel to a substrate. For example, in the memory blocks 110 having a three-dimensional structure, the memory cells may be stacked in a direction perpendicular to the substrate.

The peripheral circuits 200 may perform program, read and erase operations on a selected memory block 110 under control of the control logic 300. For example, under control of the control logic 300, the peripheral circuits 200 may supply a verify voltage and pass voltages to the first select line, the second select line, and the word lines, selectively discharge the first select line, the second select line, and the word lines, and verify memory cells coupled to a selected word line among the word lines. For instance, the peripheral circuits 200 may include a voltage generating circuit 210, a row decoder 220, a page buffer group 230, a column decoder 240, an input/output circuit 250, and a sensing circuit 260.

The voltage generation circuit 210 may generate various operating voltages Vop to be used for the program, read, and erase operations in response to an operating signal OP_CMD. Furthermore, the voltage generating circuit 210 may selectively discharge the local lines LL in response to an operating signal OP_CMD. For example, the voltage generating circuit 210 may generate a program voltage, a verify voltage, pass voltages, a turn-on voltage, a read voltage, an erase voltage, a source line voltage, etc. under control of the control logic 300.

The row decoder 220 may transmit operating voltages Vop to local lines WL coupled to a selected memory block 110 in response to a row address RADD.

The page buffer group 230 may include a plurality of page buffers PB1 to PBn (231) coupled to the bit lines BL1 to BLn. The page buffers PB1 to PBn (231) may operate in response to page buffer control signals PBSIGNALS. For instance, the page buffers PB1 to PBn (231) may temporarily store data received through the bit lines BL1 to BLn or sense voltages or currents of the bit lines BL1 to BLn during a read or verify operation.

The column decoder 240 may transmit data between the input/output circuit 250 and the page buffer group 230 in response to a column address CADD. For example, the column decoder 240 may exchange data with the page buffers 231 through data lines DL or exchange data with the input/output circuit 250 through column lines CL.

The input/output circuit 250 may transmit a command CMD or an address ADD received from the memory controller (1200 of FIG. 1) to the control logic 300, or exchange data DATA with the column decoder 240.

During the read or verify operation, the sensing circuit 260 may generate a reference current in response to an enable bit VRY_BIT<#>, and may compare a sensing voltage VPB received from the page buffer group 230 with a reference voltage generated by the reference current and output a pass signal PASS or a fail signal FAIL.

The control logic 300 may output an operating signal OP_CMD, a row address RADD, page buffer control signals PBSIGNALS, and an enable bit VRY_BIT<#> in response to a command CMD and an address ADD and thus control the peripheral circuits 200. In addition, the control logic 300 may determine whether target memory cells have passed or failed a verify operation in response to a pass or fail signal PASS or FAIL.

In the operation of the nonvolatile memory device 1100, each memory block 110 may be the basic unit of an erase operation. In other words, a plurality of memory cells included in each memory block 110 may be simultaneously erased rather than being selectively erased.

FIG. 5 is a diagram illustrating a memory block 110 in accordance with an embodiment of the present disclosure.

Referring to FIG. 5, in the memory block 110, a plurality of word lines arranged parallel to each other may be coupled between a first select line and a second select line. Here, the first select line may be a source select line SSL, and the second select line may be a drain select line DSL. In more detail, the memory block 110 may include a plurality of strings ST coupled between the bit lines BL1 to BLn and the source line SL. The bit lines BL1 to BLn may be respectively coupled to the strings ST, and the source lines SL may be coupled in common to the strings ST. The strings ST may have the same configuration; therefore, the string ST that is coupled to the first bit line BL1 will be described in detail by way of example.

The string ST may include a source select transistor SST, a plurality of memory cells F1 to F16, and a drain select transistor DST which are coupled in series to each other between the source line SL and the first bit line BL1. At least one source select transistor SST and at least one drain select transistor DST may be included in each string ST, and a larger number of memory cells than the number of memory cells F1 to F16 shown in the drawing may be included in each string ST.

A source of the source select transistor SST may be coupled to the source line SL, and a drain of the drain select transistor DST may be coupled to the first bit line BL1. The memory cells F1 to F16 may be coupled in series between the source select transistor SST and the drain select transistor DST. Gates of the source select transistors SST included in different strings ST may be coupled to the source select line SSL, gates of the drain select transistors DST may be coupled to the drain select line DSL, and gates of the memory cells F1 to F16 may be coupled to the plurality of word lines WL1 to WL16. Among the memory cells included in different strings ST, a group of memory cells coupled to each word line may be referred to as a physical page PPG. Therefore, the number of physical pages PPG included in the memory block 110 may correspond to the number of word lines WL1 to WL16.

Each memory cell may store 1-bit data. This memory cell is typically called a single level cell SLC. In this case, each physical page PPG may store data of a singe logical page LPG. Data of each logical page LPG may include data bits corresponding to the number of cells included in a single physical page PPG. Each memory cell may store 2- or more-bit data. This memory cell is typically called a multi-level cell MLC. In this case, each physical page PPG may store data of two or more logical pages LPG.

A plurality of memory cells included in each physical page PPG may be simultaneously programmed. In other words, the nonvolatile memory device 1100 may perform a program operation on a physical page (PPG) basis. A plurality of memory cells included in each memory block may be simultaneously erased. In other words, the nonvolatile memory device 1100 may perform an erase operation on a memory block basis. Here, the memory block 110 may be referred to as an erase unit block. For example, to update some data stored in one memory block 110, the entire data stored in the corresponding memory block 110 may be read, data needed to be updated among the entire data may be changed, and then the entire data may be reprogrammed to another memory block 110. The reason for this is because of the fact that, in the case where each memory block 110 is the basic unit of the erase operation of the nonvolatile memory device 1100, it is impossible to erase only some of the data stored in the memory block 110 and reprogram new data thereto. Such characteristics of the nonvolatile memory device 1100 may be one of the factors making the garbage collection operation complex.

In an embodiment, each memory block 110 may include two or more partial blocks 111a and 111b. Here, the nonvolatile memory device 1100 may perform an erase operation on a partial block basis. Each partial block 111a or 111b may be referred to as an erase unit block. For instance, the first partial block 111a may include memory cells coupled to first to eighth word lines WL1 to WL8, and the second partial block 111b may include memory cells coupled to ninth to sixteenth word lines WL9 to WL16. In other words, when erasing data stored in the first partial block 111a, the nonvolatile memory device 1100 may retain data stored in the second partial block 111b. Likewise, when erasing data stored in the second partial block 111b, the nonvolatile memory device 1100 may retain data stored in the first partial block 111a. For example, to update some data stored in the first partial block 111a, the entire data stored in the first partial block 111a may be read, data needed to be updated among the entire data may be changed, and then the entire data may be reprogrammed to a partial block 111a or 111b of another memory block 110. Here, the data programmed to the second partial block 111b may be retained as it is.

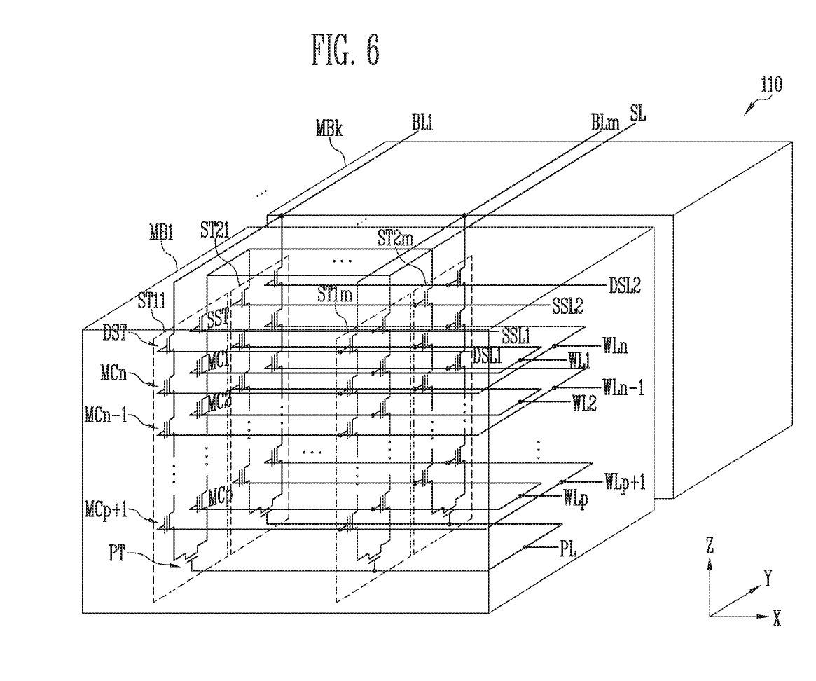

FIG. 6 is a diagram illustrating an example of a memory block having a three-dimensional structure in accordance with an embodiment of the present disclosure.

Referring to FIG. 6, the memory cell array 100 may include a plurality of memory blocks MB1 to MBk (110). Each memory block 110 may include a plurality of strings ST11 to ST1m and ST21 to ST2m. In an embodiment, each of the strings ST11 to ST1m and ST21 to ST2m may be formed in a ‘U’ shape. In the first memory block MB1, m strings may be arranged in a row direction (i.e. an X direction). In FIG. 6, there has been illustrated the case in which two strings are arranged in a column direction (i.e., in a Y direction), this is only for the sake of explanation. For example, three or more strings may be arranged in the column direction (the Y direction).

Each of the plurality of strings ST11 to ST1m and ST21 to ST2m may include at least one source select transistor SST, first to n-th memory cells MC1 to MCn, a pipe transistor PT, and at least one drain select transistor DST.

The source and drain select transistors SST and DST and the memory cells MC1 to MCn may have structures similar to each other. For example, each of the source and drain select transistors SST and DST and the memory cells MC1 to MCn may include a channel layer, a tunnel insulating layer, a charge trap layer, and a blocking insulating layer. For example, a pillar for providing the channel layer may be provided in each string. In an embodiment, a pillar for providing at least one of the channel layer, the tunnel insulating layer, the charge trap layer, and the blocking insulating layer may be provided in each string.

The source select transistor SST of each string may be coupled between the source line SL and the memory cells MC1 to MCp.

In an embodiment, source select transistors of strings arranged in the same row may be coupled to a source select line extending in the row direction. Source select transistors of strings arranged in different rows may be coupled to different source select lines. In FIG. 6, source select transistors of the strings ST11 to ST1m in a first row are coupled to a first source select line SSL1. Source select transistors of the strings ST21 to ST2m in a second row are coupled to a second source select line SSL2.

In an embodiment, the source select transistors of the strings ST11 to ST1m and ST21 to ST2m may be coupled in common to a single source select line.

The first to n-th memory cells MC1 to MCn in each string may be coupled between the source select transistor SST and the drain select transistor DST.

The first to n-th memory cells MC1 to MCn may be divided into first to p-th memory cells MC1 to MCp and p+1-th to n-th memory cells MCp+1 to MCn. The first to p-th memory cells MC1 to MCp may be sequentially arranged in a vertical direction (i.e., in a Z direction) and coupled in series to each other between the source select transistor SST and the pipe transistor PT. The p+1-th to n-th memory cells MCCp+1 to MCn may be sequentially arranged in the vertical direction (the Z direction) and coupled in series to each other between the pipe transistor PT and the drain select transistor DST. The first to p-th memory cells MC1 to MCp and the p+1-th to n-th memory cells MCp+1 to MCn may be coupled to each other through the pipe transistor PT. Gates of the first to n-th memory cells MC1 to MCn of each string may be respectively coupled to first to n-th word lines WL1 to WLn.

In an embodiment, at least one of the first to n-th memory cells MC1 to MCn may be used as a dummy memory cell. In the case where the dummy memory cell is provided, the voltage or current of the corresponding string may be stably controlled. A gate of the pipe transistor PT of each string may be coupled to a pipeline PL.

The drain select transistor DST of each string may be coupled between the corresponding bit line and the memory cells MCp+1 to MCn. Strings arranged in the row direction may be coupled to corresponding drain select lines extending in the row direction. The drain select transistors of the strings ST11 to ST1m in the first row may be coupled to a first drain select line DSL1. The drain select transistors of the strings ST21 to ST2m in the second row may be coupled to a second drain select line DSL2.

Strings arranged in the column direction may be coupled to corresponding bit lines extending in the column direction. In FIG. 6, the strings ST11 and ST21 in a first column may be coupled to a first bit line BL1. The strings ST1m and ST2m in an m-th column may be coupled to an m-th bit line BLm.

Among the strings arranged in the column direction, memory cells coupled to the same word line may form one page. For example, memory cells coupled to the first word line WL1, among the strings ST11 to ST1m in the first row, may form a single page. Memory cells coupled to the first word line WL1, among the strings ST21 to ST2m in the second row, may form another single page. When any one of the drain select lines DSL1 and DSL2 is selected, strings arranged in the corresponding row may be selected. When any one of the word lines WL1 to WLn is selected, a corresponding page of the selected strings may be selected.

A plurality of memory cells included in each memory block may be simultaneously erased. In other words, the nonvolatile memory device 1100 may perform an erase operation on a memory block basis. Here, the memory block 110 may be referred to as an erase unit block. For example, to update some data stored in one memory block 110, the entire data stored in the memory block 110 may be read, data needed to be updated among the entire data may be changed, and then the entire data may be programmed to another memory block 110. The reason for this is because of the fact that, in the case where each memory block 110 is the basic unit of the erase operation of the nonvolatile memory device 1100, it is impossible to erase only some of the data stored in the memory block 110 and program new data thereto again. Such characteristics of the memory device may be one of the factors making a garbage collection operation complex.

In an embodiment, each memory block 110 may include two or more partial blocks 111a and 111b (refer to FIG. 5). Here, the nonvolatile memory device 1100 may perform an erase operation on a partial block basis. Each partial block 111a or 111b may be referred to as an erase unit block. For instance, the first partial block 111a may include memory cells coupled to the first to p-th word lines WL1 to WLp, and the second partial block 111b may include memory cells coupled to the p+1-th to n-th word lines WLp+1 to WLn. In other words, when erasing data stored in the first partial block 111a, the nonvolatile memory device 1100 may retain data stored in the second partial block 111b. Likewise, when erasing data stored in the second partial block 111b, the nonvolatile memory device 1100 may retain data stored in the first partial block 111a. For example, to update some data stored in the first partial block 111a, the entire data stored in the first partial block 111a may be read, data needed to be updated among the entire data may be changed, and then the entire data may be reprogrammed to a partial block 111a or 111b of another memory block 110. Here, the data programmed to the second partial block 111b may be retained as it is.

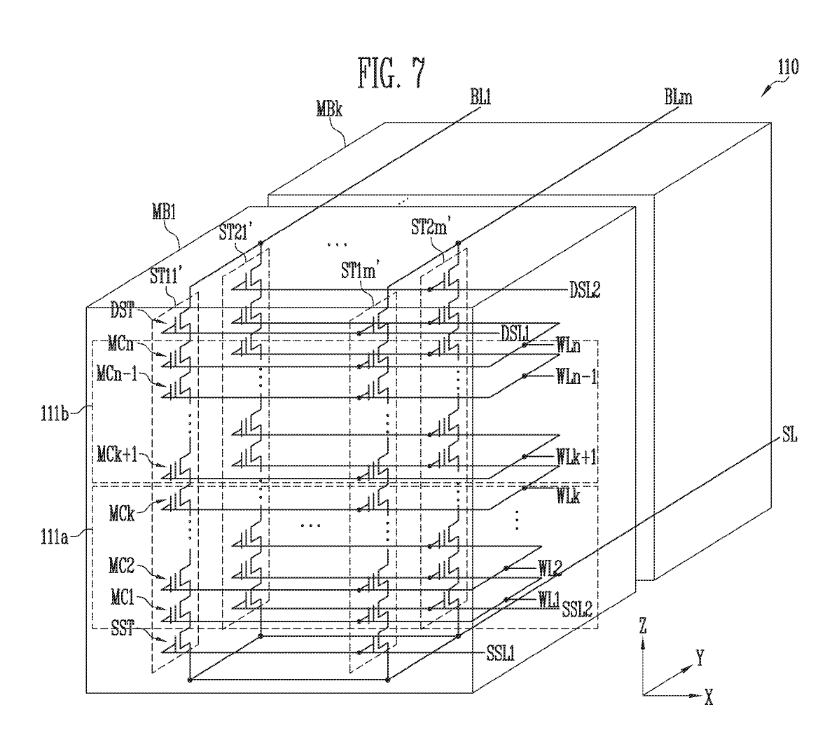

FIG. 7 is a diagram illustrating an example of a memory block having a three-dimensional structure in accordance with an embodiment of the present disclosure.

Referring to FIG. 7, the memory cell array 100 may include a plurality of memory blocks MB1 to MBk (110). Each memory block 110 may include a plurality of strings ST11′ to ST1m′ and ST21′ to ST2m′. Each of the strings ST11′ to ST1m′ and ST21′ to ST2m′ may extend in a vertical direction (i.e., in a Z direction). In each memory block 110, m strings may be arranged in a row direction (i.e., in an X direction). In FIG. 7, there has been illustrated the case where two strings are arranged in a column direction (i.e., in a Y direction), this is only for the sake of explanation. For example, three or more strings may be arranged in the column direction (the Y direction).

Each of the strings ST11′ to ST1m′ and ST21′ to ST2m′ may include at least one source select transistor SST, first to n-th memory cells MC1 to MCn, and at least one drain select transistor DST.

The source select transistor SST of each string may be coupled between the source line SL and the memory cells MC1 to MCn. Source select transistors of strings arranged in the same row may be coupled to the same source select line. The source select transistors of the strings ST11′ to ST1m′ arranged in a first row may be coupled to a first source select line SSL1. The source select transistors of the strings ST21′ to ST2m′ arranged in a second row may be coupled to a second source select line SSL2. In an embodiment, the source select transistors of the strings ST11′ to ST1m′ and ST21′ to ST2m′ may be coupled in common to a single source select line.

The first to n-th memory cells MC1 to MCn in each string may be coupled in series between the source select transistor SST and the drain select transistor DST. Gates of the first to n-th memory cells MC1 to MCn may be respectively coupled to first to n-th word lines WL1 to WLn.

In an embodiment, at least one of the first to n-th memory cells MC1 to MCn may be used as a dummy memory cell. In the case where the dummy memory cell is provided, the voltage or current of the corresponding string may be stably controlled. Thereby, the reliability of data stored in each memory block 110 may be improved.

The drain select transistor DST of each string may be coupled between the corresponding bit line and the memory cells MC1 to MCn. Drain select transistors DST of strings arranged in the row direction may be coupled to corresponding drain select lines. The drain select transistors DST of the strings ST11′ to ST1m′ in the first row may be coupled to a first drain select line DSL1. The drain select transistors DST of the strings ST21′ to ST2m′ in the second row may be coupled to a second drain select line DSL2.

In other words, the memory block 110 of FIG. 7 may have an equivalent circuit similar to that of the memory block 110 of FIG. 6 except that a pipe transistor PT is excluded from each cell string.

A plurality of memory cells included in each memory block may be simultaneously erased. In other words, the nonvolatile memory device 1100 may perform an erase operation on a memory block basis. Here, the memory block 110 may be referred to as an erase unit block. For example, to update some data stored in one memory block 110, the entire data stored in the memory block 110 may be read, data needed to be updated among the entire data may be changed, and then the entire data may be programmed to another memory block 110. The reason for this is because of the fact that, in the case where each memory block 110 is the basic unit of the erase operation of the nonvolatile memory device 1100, it is impossible to erase only some of the data stored in the memory block 110 and program new data thereto again. Such characteristics of the memory device may be one of the factors making a garbage collection operation complex.

In an embodiment, each memory block 110 may include two or more partial blocks 111a and 111b. Here, the nonvolatile memory device 1100 may perform an erase operation on a partial block basis. Each partial block 111a or 111b may be referred to as an erase unit block. For instance, the first partial block 111a may include memory cells coupled to the first to k-th word lines WL1 to WLk, and the second partial block 111b may include memory cells coupled to the k+1-th to n-th word lines WLk+1 to WLn. In other words, when erasing data stored in the first partial block 111a, the nonvolatile memory device 1100 may retain data stored in the second partial block 111b. Likewise, when erasing data stored in the second partial block 111b, the nonvolatile memory device 1100 may retain data stored in the first partial block 111a. For example, to update some data stored in the first partial block 111a, the entire data stored in the first partial block 111a may be read, data needed to be updated among the entire data may be changed, and then the entire data may be reprogrammed to a partial block 111a or 111b of another memory block 110. Here, the data programmed to the second partial block 111b may be retained as it is.

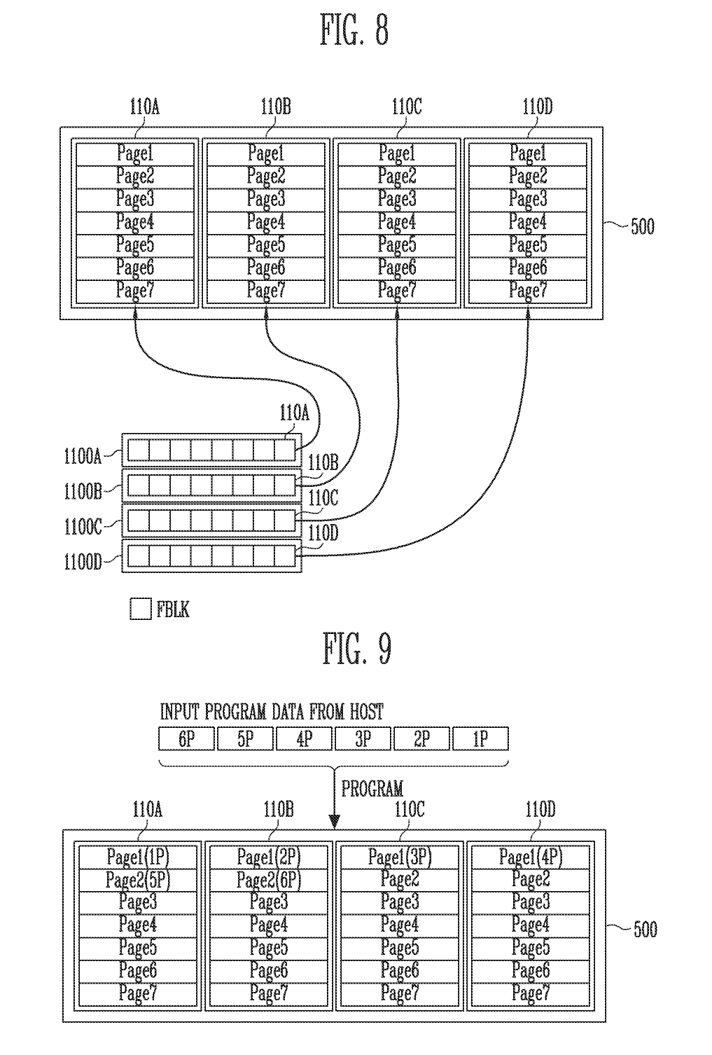

FIG. 8 is a diagram illustrating a method of generating a super block 500 in accordance with an embodiment of the present disclosure.

Referring to FIG. 8, the memory system 1000 may include a plurality of nonvolatile memory devices 1100. For instance, the memory system 1000 may include a first nonvolatile memory device 1100A, a second nonvolatile memory device 1100B, a third nonvolatile memory device 1100C, and a fourth nonvolatile memory device 1100D. Each of the first nonvolatile memory device 1100A, the second nonvolatile memory device 1100B, the third nonvolatile memory device 1100C, and the fourth nonvolatile memory device 1100D may include a plurality of memory blocks 110. For example, each of the first to fourth nonvolatile memory devices 1100A to 1100D may include eight memory blocks 110. This is only for the sake of explanation; therefore, the bounds of the present disclosure are not limited thereto.

Each of the memory blocks 110 may be a free block FBLK or a programmed block PBLK. The free block FBLK may be an erased block. In other words, the free block FBLK may be a memory block 110 in which no data has been written. When the unit of an erase operation of the nonvolatile memory device 1100 is the memory block 110, the free block FBLK may correspond to the memory block 110. In an embodiment, when the unit of an erase operation of the nonvolatile memory device 1100 is the partial block 111a or 111b, the free block FBLK may correspond to the partial block 111a or 111b. The programmed block PBLK may be a memory block 110 in which data has been programmed. Until the programmed block PBLK becomes block closed, additional data may be programmed to the programmed block PBLK. In the “block closed” block, additional data cannot be programmed since the block closed block is full of programmed data and does not have a memory space for the additional data.

For example, the first nonvolatile memory device 1100A may include a plurality of first free blocks (FBLK) 110A. The second nonvolatile memory device 1100B may include a plurality of second free blocks (FBLK) 110B. The third nonvolatile memory device 1100C may include a plurality of third free blocks (FBLK) 110C. The fourth nonvolatile memory device 1100D may include a plurality of fourth free blocks (FBLK) 110D.

Each of the first to fourth nonvolatile memory devices 1100A, 1100B, 1100C, and 1100D may be coupled to a single channel and form a different way. For example, each of the first to fourth nonvolatile memory devices 1100A, 1100B, 1100C, and 1100D may be coupled to the first channel CH1 of FIG. 3. The first nonvolatile memory device 1100A may form the first way Way1, the second nonvolatile memory device 1100B may form the second way Way2, the third nonvolatile memory device 1100C may form the third way Way3, and the fourth nonvolatile memory device 1100D may form the fourth way Way4. As described with reference to FIG. 3, the first to fourth nonvolatile memory devices 1100A, 1100B, 1100C, and 1100D that are coupled to the single channel and form different ways may perform a program operation in succession or in parallel.

The memory system 1000 may generate one super block (SBLK) 500 with one first free block (FBLK) 110A included in the first nonvolatile memory device 1100A, one second free block (FBLK) 110B included in the second nonvolatile memory device 1100B, one third free block (FBLK) 110C included in the third nonvolatile memory device 1100C, and one fourth free block (FBLK) 110D included in the fourth nonvolatile memory device 1100D. In other words, the super block 500 may be formed of memory blocks 110 that are respectively selected from a plurality of nonvolatile memory devices 1100 coupled to one channel. Here, each memory block 110 may be an erase unit block. In an embodiment, the super block 500 may be formed of partial blocks 111a or 111b that are respectively selected from a plurality of nonvolatile memory devices 1100 coupled to one channel. Here, each partial block 111a or 111b may be an erase unit block. That is, the erase unit block of the nonvolatile memory device 1100 may be a memory block 110 or, alternatively, a partial block 111a or 111b. In other words, the super block 500 may be formed of erase unit blocks that are respectively selected from a plurality of nonvolatile memory devices 1100 coupled to one channel. That is, the super block 500 may be formed of memory blocks 110, or alternatively, partial blocks 111a or 111b that are respectively selected from a plurality of nonvolatile memory devices 1100 coupled to one channel.

Each of the memory blocks 110 of the nonvolatile memory devices 1100 may include a plurality of physical pages (PPG). Each physical page (PPG) may include one or more pages (PG). In other words, each of the memory blocks 110 of the nonvolatile memory devices 1100 may include a plurality of pages PG1 to PGn. For example, in the case of a single level cell (SLC) which stores 1-bit data in each memory cell, each physical page (PPG) may correspond to a single page (PG). In an embodiment, in the case of a multi-level cell (MLC) which stores 2- or more-bit data in each memory cell MC, each physical page (PPG) may correspond to two or more pages (PG). In the case of the multi-level cell (MLC), two or more pages (PG) corresponding to each physical page (PPG) may have different threshold voltages. For example, each of the first free block (FBLK) 110A, the second free block (FBLK) 110B, the third free block (FBLK) 110C, and the fourth free block (FBLK) 110D may include first to seventh pages page1 to Page 7. This is only for the sake of explanation; therefore, the bounds of the present disclosure are not limited thereto.

FIG. 9 is a diagram illustrating a method for programming program data to the super block 500 in accordance with an embodiment of the present disclosure.

Referring to FIG. 9, the memory system 1000 may receive program data from the host 2000. For instance, the program data input from the host 2000 may include first to sixth program page data 1P to 6P.

The memory controller 1200 may select, to form a super block 500, first to fourth free blocks (FBLK) 110A to 110D from the respective first to fourth nonvolatile memory devices 1100A, 1100B, 1100C, and 1100D that are coupled to a single channel and form different ways, and then program the first to sixth program page data 1P to 6P to the super block 500. Here, the first program page data 1P is programmed to a first page Page1 of the first free block (FBLK) 110A of the super block 500. The second program page data 2P is programmed to a first page Page1 of the second free block (FBLK) 110B of the super block 500. The third program page data 3P is programmed to a first page Page1 of the third free block (FBLK) 110C of the super block 500. The fourth program page data 4P is programmed to a first page Page1 of the fourth free block (FBLK) 110D of the super block 500. The fifth program page data 5P is programmed to a second page Page2 of the first free block (FBLK) 110A of the super block 500. The sixth program page data 6P is programmed to a second page Page2 of the second free block (FBLK) 110B of the super block 500.

Here, the first to fourth program page data 1P to 4P may be programmed in parallel to the respective first pages Page1 of the first to fourth free blocks (FBLK) 110A to 110D, whereby the time taken to perform the program operation may be reduced. In other words, compared to the case where the first to fourth program page data 1P to 4P may be sequentially programmed to the respective first pages Page1 of the first to fourth free blocks (FBLK) 110A to 110D, the time taken to perform the program operation in the parallel manner may be reduced. Furthermore, the fifth and sixth program page data 5P and 6P may be programmed in parallel to the respective second pages Page 2 of the first and second free blocks (FBLK) 110A and 110B.

As described above, the memory system 1000 may form the super block 500 and program the program data in parallel, thus enhancing the programming performance.

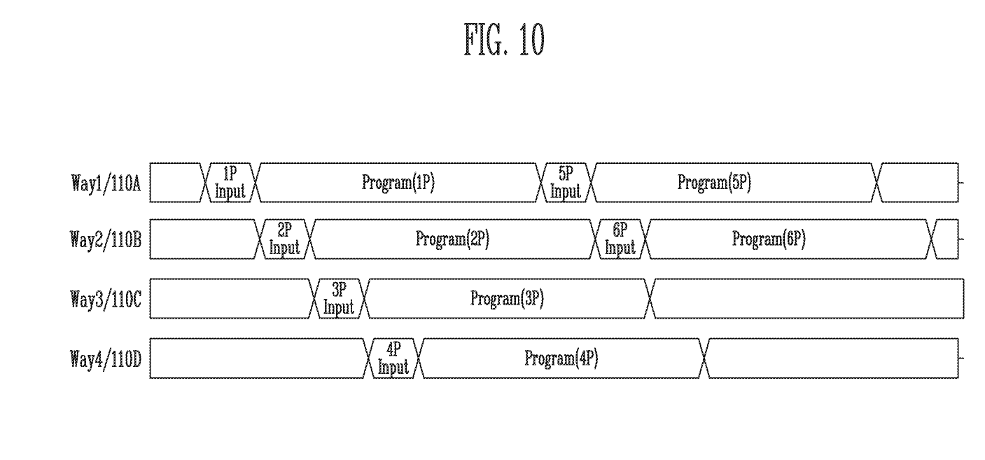

FIG. 10 is a timing diagram illustrating an operation of programming program data to the super block 500 in accordance with an embodiment of the present disclosure.

Referring to FIG. 10, when the memory system 1000 receives the first to sixth program page data 1P to 6P from the host 2000, the memory system 1000 may program the first to sixth program page data 1P to 6P to the super block 500. The first to fourth free blocks (FBLK) 110A to 110D forming the super block 500 may be coupled to the first channel CH1. Furthermore, the first to fourth free blocks (FBLK) 110A to 110D may respectively form first to fourth ways Way1 to Way4.

As described above, a plurality of ways (e.g., the first to fourth ways Way1 to Way4) forming a single channel (e.g., the first channel CH1) may not simultaneously share the channel. In other words, if any one of the ways forming the single channel occupies the channel, the other ways must wait until the occupied channel is released. Therefore, when performing a program operation on the super block 500, the memory controller 1200 may input the first program page data 1P to the first nonvolatile memory device 1100A forming the first way Way1 through the first channel CH1. After the operation of inputting the first program page data 1P to the first nonvolatile memory device 1100A has been completed, i.e., after the occupied first channel CH1 by the first nonvolatile memory device 1100A is released, the memory controller 1200 may input the second program page data 2P to the second nonvolatile memory device 1100B through the first channel CH1. In other words, the memory controller 1200 may sequentially input program data P1 to P6 to the first to fourth nonvolatile memory devices 1100A to 1100D forming the first to fourth ways Way1 to Way4 through the first channel CH1.

As such, after having received the program data, the first to fourth nonvolatile memory devices 1100A to 1100D coupled to the first channel CH1 may perform a program operation in parallel on the first to fourth free blocks (FBLK) 110A to 110D included in the single super block 500. Consequently, the program operation may be simultaneously performed on the memory blocks 110 forming the single super block 500. That is, the memory blocks 110 included in the single super block 500 may be logically operated as a single memory block. As described above, if the program data P1 to P6 are programmed to the first to fourth free blocks (FBLK) 110A to 110D, the first to fourth free blocks (FBLK) 110A to 110D may be no longer free blocks but become programmed blocks PBLK.

In an embodiment, when performing an erase operation on the super block 500 on which the program operation has been performed, the memory controller 1200 may input an erase command to the first nonvolatile memory device 1100A forming the first way Way1 through the first channel CH1. After the operation of inputting the erase command to the first nonvolatile memory device 1100A has been completed, i.e., after the first channel CH1 occupied by the first nonvolatile memory device 1100A becomes released, the memory controller 1200 may input an erase command to the second nonvolatile memory device 1100B. In other words, the memory controller 1200 may sequentially input erase commands to the first to fourth nonvolatile memory devices 1100A to 1100D forming the first to fourth ways Way1 to Way4 through the first channel CH1.

As such, after having received the erase commands, the first to fourth nonvolatile memory devices 1100A to 1100D coupled to the first channel CH1 may perform an erase operation in parallel on the first to fourth programmed blocks (PBLK) 110A to 110D included in the single super block 500. Consequently, the erase operation may be simultaneously performed on the memory blocks 110 forming the single super block 500. In other words, the memory blocks 110 included in the single super block 500 may be logically operated as a single memory block. The memory system 1000 may manage the super block as a single memory block. In other words, the memory block 110 may be physically the unit of an erase operation, but the super block 500 may be managed as the unit of an erase operation in terms of the operation.

In an embodiment, the memory system 1000 may manage the super block 500 as a single memory block when performing a program operation, and independently manage each of the memory blocks 110 included in the single super block 500 when performing an erase operation. In other words, the memory system 1000 may manage, to enhance the programming performance, the super block 500 as a single memory block when performing a program operation, and independently manage, to improve the efficiency of the garbage collection operation, each of the memory blocks 110 included in the single super block 500 when performing the erase operation. In an embodiment, the memory system 1000 may independently manage, to improve the efficiency of the garbage collection operation, each of the partial blocks 111a and 111b included in the single super block 500 when performing the erase operation. This will be described in detail later herein.

The memory blocks 110 forming the super block 500 may not be simultaneously programmed. For example, after the fifth program page data 5P is programmed to the second page Page2 of the first memory block 110A forming the super block 500, the sixth program page data 6P may be programmed to the second page Page 2 of the second memory block 110B. Here, a program operation may not be performed on the third and fourth memory block 110C and 110D.

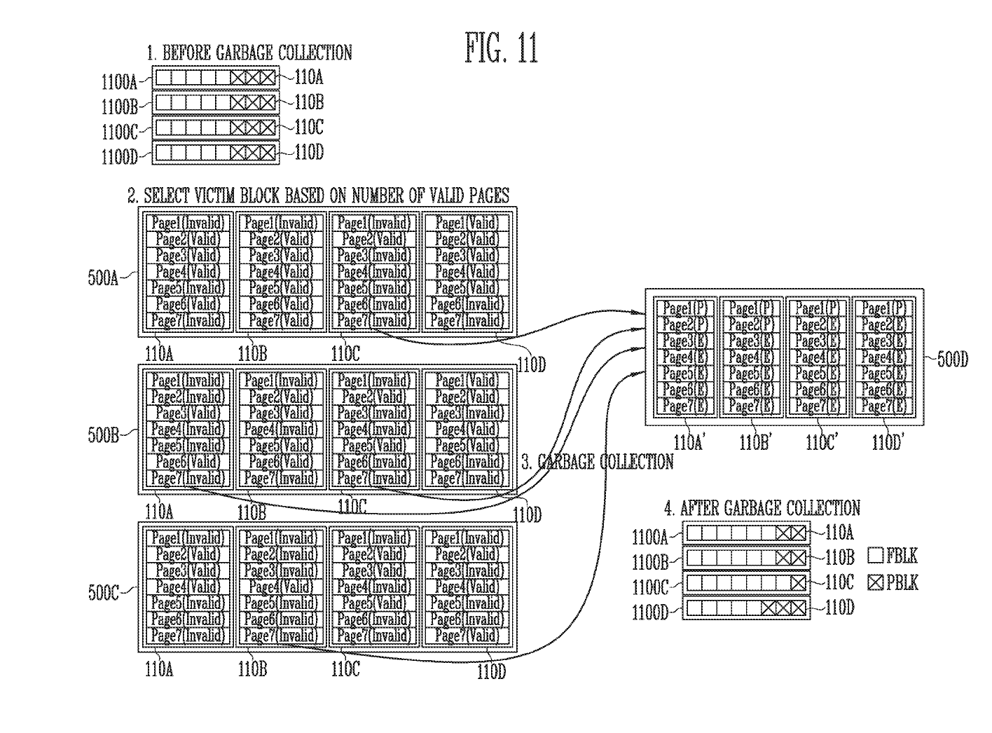

FIG. 11 is a diagram illustrating a garbage collection operation in accordance with an embodiment of the present disclosure.

Referring to FIG. 11, in an embodiment, the memory system 1000 may generate first to third super blocks (SBLK) 500A, 500B, and 500C with free blocks (FBLK) 110A to 110D from the first to fourth nonvolatile memory devices 1100A, 1100B, 1100C, and 1100D. Furthermore, a program operation may be performed on the first to third super blocks (SBLK) 500A, 500B, and 500C as described with reference to FIGS. 9 and 10. Before the garbage collection operation is performed, each of the first to fourth nonvolatile memory devices 1100A, 1100B, 1100C, and 1100D may include three programmed blocks (PBLK) 100A, 100B, 100C, 100D, and five free blocks (FBLK) 100A, 100B, 100C, 100D (refer to “1. BEFORE GARBAGE COLLECTION” in FIG. 11).

Each of pages included in the memory blocks 110A to 110D of each of the first to third super blocks (SBLK) 500A, 500B, and 500C may store valid page data or invalid page data. A valid page stores valid page data. An invalid page stores invalid page data. The valid page data must be retained in the nonvolatile memory device 1100. The invalid page data may be erased from the nonvolatile memory device 1100. Through the garbage collection operation, the memory system 1000 may copy the valid page data to a memory block 110 of another super block (SBLK) 500 and erase the invalid page data. In other words, through the garbage collection operation, the memory system 1000 may copy the valid page data of a memory block 110 of a super block (SBLK) 500 to a corresponding memory block 110 of another super block (SBLK) 500, and erase the memory block 110 of the copied valid page data, to use the memory block 110 of the copied valid page data as a free block FBLK.

The above-mentioned garbage collection operation may be performed based on the number of valid pages or invalid pages included in the memory blocks 110A to 110D. In other words, the garbage collection operation may be preferentially performed on a memory block that has the smallest number of valid pages among the memory blocks 110A to 110D. In other words, the garbage collection operation may be preferentially performed on a memory block that has the largest number of invalid pages among the memory blocks 110A to 110D.

In detail, the memory controller 1200, may manage information about valid pages or invalid pages of each of the memory blocks 110 included in the super block 500. For example, in a first super block (SBLK) 500A, a first programmed block (PBLK) 110A may include four valid pages, a second programmed block (PBLK) 110B may include six valid pages, a third programmed block (PBLK) 110C may include one valid page, and a fourth programmed block (PBLK) 110D may include five valid pages. Furthermore, in a second super block (SBLK) 500B, a first programmed block (PBLK) 110A may include two valid pages, a second programmed block (PBLK) 110B may include four valid pages, a third programmed block (PBLK) 110C may include two valid pages, and a fourth programmed block (PBLK) 110D may include four valid pages. Furthermore, in a third super block (SBLK) 500C, a first programmed block (PBLK) 110A may include three valid pages, a second programmed block (PBLK) 110B may include one valid page, a third programmed block (PBLK) 110C may include three valid page, and a fourth programmed block (PBLK) 110D may include three valid pages.

Among the memory blocks 110A to 110D included in the first to third super blocks (SBLK) 500A, 500B, and 500C, four memory blocks 110 having the smallest number of valid pages, i.e., the third programmed block (PBLK) 110C of the first super block (SBLK) 500A, the first programmed block (PBLK) 110A and the third programmed block (PBLK) 110C of the second super block (SBLK) 500B, and the second programmed block (PBLK) 110B of the third super block (SBLK) 500C, may be selected as victim blocks (refer to “2. SELECT VICTIM BLOCK BASED ON NUMBER OF VALID PAGES” in FIG. 11). In the foregoing example, the reason why the four memory blocks 110 having the smallest number of valid pages are selected as victim blocks may be because each super block (SBLK) 500 is formed of four memory blocks 110. In other words, if each super block (SBLK) 500 is formed of N memory blocks 110, N victim blocks may be selected for a garbage collection operation (where, N is a natural number of 2 or more).

In the foregoing example, the garbage collection operation may be performed on the selected victim blocks, i.e., the third programmed block (PBLK) 110C of the first super block (SBLK) 500A, the first programmed block (PBLK) 110A and the third programmed block (PBLK) 110C of the second super block (SBLK) 500B, and the second programmed block (PBLK) 110B of the third super block (SBLK) 500C. In other words, valid page data stored in the valid pages of the third programmed block (PBLK) 110C of the first super block (SBLK) 500A, the first programmed block (PBLK) 110A and the third programmed block (PBLK) 110C of the second super block (SBLK) 500B, and the second programmed block (PBLK) 110B of the third super block (SBLK) 500C, may be copied to the fourth super block (SBLK) 500D. In detail, six valid page data stored in the third programmed block (PBLK) 110C of the first super block (SBLK) 500A, the first programmed block (PBLK) 110A and the third programmed block (PBLK) 110C of the second super block (SBLK) 500B, and the second programmed block (PBLK) 110B of the third super block (SBLK) 500C, may be respectively copied to six free pages of the fourth super block (SBLK) 500D, e.g., first pages Page1 of first to fourth memory blocks 110A′ to 110D′ of the fourth super block (SBLK) 500D and second pages Page2 of the first and second memory blocks 110A′ and 110B′ (refer to “3. GARBAGE COLLECTION” in FIG. 11). Here, the memory system 1000 may copy the valid page data in parallel to the respective first pages Page1 of the first to fourth memory blocks 110A′ to 110D′ of the fourth super block (SBLK) 500D. That is, the first to fourth memory blocks 110A′ to 110D′ of the fourth super block (SBLK) 500D may be respectively included in nonvolatile memory devices 1100 that form different ways. For example, the fourth super block (SBLK) 500D may be coupled to a channel different from that of the first to third super blocks (SBLK) 500A, 500B, and 500C.

After the garbage collection operation has been performed, an erase operation may be performed on the selected victim blocks, i.e., the third programmed block (PBLK) 110C of the first super block (SBLK) 500A, the first programmed block (PBLK) 110A and the third programmed block (PBLK) 110C of the second super block (SBLK) 500B, and the second programmed block (PBLK) 110B of the third super block (SBLK) 500C. The third programmed block (PBLK) 110C of the first super block (SBLK) 500A, the first programmed block (PBLK) 110A and the third programmed block (PBLK) 110C of the second super block (SBLK) 500B, and the second programmed block (PBLK) 110B of the third super block (SBLK) 500C, on which the erase operation has been performed, may become free blocks again (refer to “4. AFTER GARBAGE COLLECTION” in FIG. 11). Therefore, the first nonvolatile memory device 1100A may further secure one free block (FBLK) 110A, compared to that before the garbage collection operation is performed. The second nonvolatile memory device 1100B may further secure one free block (FBLK) 110B, compared to that before the garbage collection operation is performed. The third nonvolatile memory device 1100C may further secure two free blocks (FBLK) 110C, compared to that before the garbage collection operation is performed.

As described above, the memory controller 1200, may individually manage information about valid pages or invalid pages of each of the memory blocks 110 included in the super block 500. Furthermore, when the garbage collection operation is performed, the memory system 1100 may select victim blocks on an individual memory block basis rather than on a super block basis, and perform the garbage collection operation on the selected victim blocks and secure free blocks. Here, the memory block 110 may be the unit of an erase operation. In an embodiment, when each memory block 110 includes a plurality of partial blocks 111a and 111b, the memory controller 1200 may individually manage information about valid pages or invalid pages of each of partial blocks 111 included in the super block 500. When a garbage collection operation is performed, the memory system 1100 may select victim blocks on a partial block basis rather than a super block basis, and perform the garbage collection operation on the selected victim blocks and secure free blocks. Here, each partial block 111a or 111b may be the unit of an erase operation.

As described above, the memory controller 1200, may individually manage information about valid pages or invalid pages of each of a plurality of erase unit blocks included in the super block 500. Furthermore, when the garbage collection operation is performed, the memory system 1100 may select victim blocks on an individual erase unit block basis rather than on a super block basis, and perform the garbage collection operation on the selected victim blocks and secure free blocks.

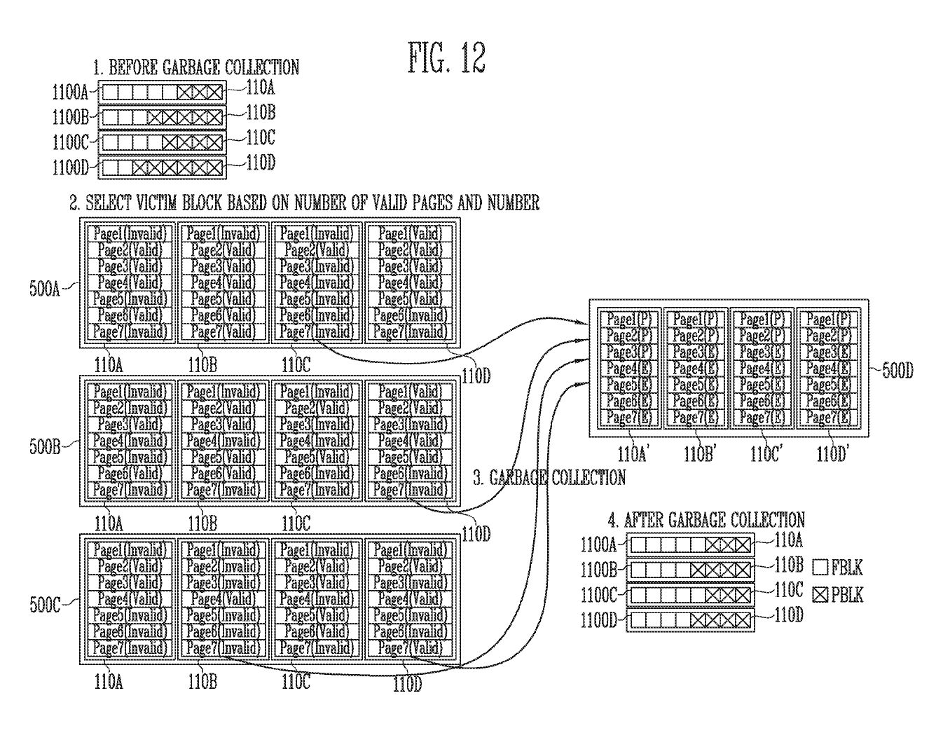

FIG. 12 is a diagram illustrating a garbage collection operation in accordance with an embodiment of the present disclosure.

Referring to FIG. 12, in an embodiment, the memory system 1000 may generate first to third super blocks (SBLK) 500A, 500B, and 500C with free blocks (FBLK) 110A to 110D from the first to fourth nonvolatile memory devices 1100A, 1100B, 1100C, and 1100D.

Furthermore, a program operation may be performed on the first to third super blocks (SBLK) 500A, 500B, and 500C as described with reference to FIGS. 9 and 10. For example, before the garbage collection operation is performed (refer to “1. BEFORE GARBAGE COLLECTION” in FIG. 12), the first nonvolatile memory device 1100A may include five free blocks (FBLK) 110A and three programmed blocks (PBLK) 110A, and the second nonvolatile memory device 1100B may include three free blocks (FBLK) 110B and five programmed blocks (PBLK) 110B. In addition, before the garbage collection operation is performed, the third nonvolatile memory device 1100C may include four free blocks (FBLK) 110C and four programmed blocks (PBLK) 110C, and the fourth nonvolatile memory device 1100D may include two free blocks (FBLK) 110D and six programmed blocks (PBLK) 110D.

The garbage collection operation may be performed based on the number of free blocks FBLK included in each of the nonvolatile memory devices 1100A to 1100D and the number of valid pages or invalid pages included in the memory blocks 110A to 110D. In other words, the garbage collection operation may be preferentially performed on a nonvolatile memory device having the smallest number of free blocks among the nonvolatile memory devices 1100A to 1100D, and may be preferentially performed on a memory block having the smallest number of valid pages among the memory blocks 110A to 110D.

The memory controller 1200, may manage information about the number of free blocks FBLK included in each of the nonvolatile memory devices 1100A to 1100D, and may manage information about valid pages or invalid pages of each of the memory blocks 110 included in the super block 500. In other words, the memory controller 1200, may individually manage the information about the number of free blocks FBLK included in each of the nonvolatile memory devices 1100A to 1100D, and may manage the information about valid pages or invalid pages of each of the memory blocks 110 included in the super block 500.

For example, in a first super block (SBLK) 500A, a first programmed block (PBLK) 110A may include four valid pages, a second programmed block (PBLK) 110B may include six valid pages, a third programmed block (PBLK) 110C may include one valid page, and a fourth programmed block (PBLK) 10D may include five valid pages. Furthermore, in a second super block (SBLK) 500B, a first programmed block (PBLK) 110A may include two valid pages, a second programmed block (PBLK) 110B may include four valid pages, a third programmed block (PBLK) 110C may include two valid page, and a fourth programmed block (PBLK) 110D may include four valid pages. Furthermore, in a third super block (SBLK) 500C, a first programmed block (PBLK) 110A may include three valid pages, a second programmed block (PBLK) 110B may include one valid page, a third programmed block (PBLK) 110C may include three valid page, and a fourth programmed block (PBLK) 110D may include three valid pages.

For example, referring to “2. SELECT VICTIM BLOCK BASED ON NUMBER OF VALID PAGES AND NUMBER” in FIG. 12, the memory controller 1200, may first select, as victim blocks, memory blocks having the smallest number of valid pages among memory blocks in the fourth nonvolatile memory device 1100D having the smallest number of free blocks FBLK, which are the fourth programmed blocks (PBLK) 110D of the second super block (SBLK) 500B and the third super block (SBLK) 500C. Furthermore, the memory controller 1200 may select, as a victim block, a memory block having the smallest number of valid pages among memory blocks in the second nonvolatile memory device 1100B having the second smallest number of free blocks, which is the second programmed block (PBLK) 110B of the third super block (SBLK) 500C. Lastly, the memory controller 1200 may select, as a victim block, a memory block having the smallest number of valid pages among memory blocks in the third nonvolatile memory device 1100C having the third smallest number of free blocks, which is the third programmed block (PBLK) 110C of the first super block (SBLK) 500A.

As described above, valid page data stored in the valid pages of the third programmed block (PBLK) 110C of the first super block (SBLK) 500A, the fourth programmed block (PBLK) 110D of the second super block (SBLK) 500B, and the second programmed block (PBLK) 110B and the fourth programmed block (PBLK) 110D of the third super block (SBLK) 500C may be copied to the fourth super block (SBLK) 500D. In other words, nine valid page data stored in the third programmed block (PBLK) 110C of the first super block (SBLK) 500A, the fourth programmed block (PBLK) 110D of the second super block (SBLK) 500B, and the second programmed block (PBLK) 110B and the fourth programmed block (PBLK) 110D of the third super block (SBLK) 500C, may be respectively copied to nine free pages of the fourth super block (SBLK) 500D, e.g., first and second pages Page1 and Page2 of first to fourth memory blocks 110A′ to 110D′ of the fourth super block (SBLK) 500D and a third page Page3 of the first memory block 110A′ (refer to “3. GARBAGE COLLECTION” in FIG. 12). Here, the memory system 1000 may copy the valid page data in parallel to the respective first pages Page1 of the first to fourth memory blocks 110A′ to 110D′ of the fourth super block (SBLK) 500D. Furthermore, the memory system 1000 may copy the valid page data in parallel to the respective second pages Page2 of the first to fourth memory blocks 110A′ to 110D′ of the fourth super block (SBLK) 500D. That is, the first to fourth memory blocks 110A′ to 110D′ of the fourth super block (SBLK) 500D may be respectively included in nonvolatile memory devices 1100 that form different ways. For example, the fourth super block (SBLK) 500D may be coupled to a channel different from that of the first to third super blocks (SBLK) 500A, 500B, and 500C.

After the garbage collection operation has been performed, an erase operation may be performed on the selected victim blocks, i.e., the third programmed block (PBLK) 110C of the first super block (SBLK) 500A, the fourth programmed block (PBLK) 110D of the second super block (SBLK) 500B, and the second programmed block (PBLK) 110B and the fourth programmed block (PBLK) 110D of the third super block (SBLK) 500C. The third programmed block (PBLK) 110C of the first super block (SBLK) 500A, the fourth programmed block (PBLK) 110D of the second super block (SBLK) 500B, and the second programmed block (PBLK) 110B and the fourth programmed block (PBLK) 110D of the third super block (SBLK) 500C, on which the erase operation has been performed, may become free blocks again (refer to “4. AFTER GARBAGE COLLECTION” in FIG. 12). Therefore, the first nonvolatile memory device 1100A may include the same number of free blocks (FBLK) 110A as that before the garbage collection operation is performed. The second nonvolatile memory device 1100B may further secure one free block (FBLK) 110B, compared to that before the garbage collection operation is performed. The third nonvolatile memory device 1100C may further secure one free block (FBLK) 110C, compared to that before the garbage collection operation is performed. The fourth nonvolatile memory device 1100D may further secure two free blocks (FBLK) 110D, compared to that before the garbage collection operation is performed.

As a result, the number of free blocks FBLK included in each of the first to fourth nonvolatile memory devices 1100A, 1100B, 1100C, and 1100D may be more uniform than that before the garbage collection operation is performed.

In an embodiment, the garbage collection operation may be performed based on the number of free blocks FBLK included in each of the nonvolatile memory devices 1100A to 1100D, the number of valid pages included in the memory blocks 110A to 10D, and a wear-leveling level of each of the memory blocks 110A to 10D. The wear-leveling level of each of the memory blocks 110A to 110D may mean the number of program-erase cycles performed on each of the memory blocks 110A to 110D. In other words, the higher the number of the program-erase cycles, the higher the wear-leveling level. The wear-leveling level of the memory block 110 may represent the degree of deterioration of the memory block 110. The memory system 1000 may preferentially perform the garbage collection operation on a memory block 110 having lower wear-leveling level. In other words, the memory system 1000 may preferentially select the memory block having lower wear-leveling level as a victim block. Thereby, the wear-leveling levels of the memory blocks 110 included in the memory system 1000 may be managed to be uniform.

FIG. 13 is a diagram illustrating the memory controller 1200 in accordance with an embodiment of the present disclosure.

Referring to FIG. 13, the memory controller 1200 may further include a host write control section 1202, a garbage collection control section 1203, a valid page information management section 1204, a free block information management section 1205, and wear leveling information management section 1206.

The host write control section 1202 may be included in the processor 710 of FIG. 2. In the case where program page data is input from the host 2000 to the memory system 1000, the host write control section 1202 may control the nonvolatile memory devices 1100 to program the program page data to the super block (SBLK) 500. For example, when the super block (SBLK) 500 is configured of the first memory block 110A of the first nonvolatile memory device 1100A, the second memory block 110B of the second nonvolatile memory device 1100B, the third memory block 110C of the third nonvolatile memory device 1100C, and the fourth memory block 110D of the fourth nonvolatile memory device 1100D, the host write control section 1202 may control the first to fourth nonvolatile memory devices 1100A to 1100D to program the program page data to the first to fourth memory blocks 110A to 110D in parallel. Thereby, the programming performance of the memory system 1000 may be enhanced. In other words, the host write control section 1202 may perform the program operation on a super block basis.

The valid page information management section 1204 may be included in the memory buffer 720 of FIG. 2. Alternatively, the valid page information management section 1204 may be included in the buffer memory device 1300 of FIG. 1. The valid page information management section 1204 may manage information about valid pages or invalid pages included in the first to fourth memory blocks 110A to 110D included in the super block (SBLK) 500. In other words, the valid page information management section 1204 may individually manage information about valid pages or invalid pages of each of the memory blocks 110 included in the super block (SBLK) 500. In an embodiment, the valid page information management section 1204 may individually manage information about the number of valid pages or invalid pages included in each of the memory blocks 110 included in the super block (SBLK) 500. In an embodiment, the valid page information management section 1204 may manage information about page indexes of valid pages or page indexes of invalid pages included in each of the memory blocks 110 included in the super block (SBLK) 500. The valid page information management section 1204 may include an embedded SRAM. In an embodiment, the valid page information management section 1204 may include a DRAM.

The free block information management section 1205 may be included in the memory buffer 720 of FIG. 2. Alternatively, the free block information management section 1205 may be included in the buffer memory device 1300 of FIG. 1. The free block information management section 1205 may manage information about free blocks FBLK or programmed blocks PBLK among a plurality of memory blocks 110 included in each nonvolatile memory device 1100. In other words, the free block information management section 1205 may manage the information about whether each of the plurality of memory blocks 110 included in each of the nonvolatile memory devices 1100 is a free block FBLK or a programmed block PBLK. In an embodiment, the free block information management section 1205 may manage the information about the number of free blocks FBLK or programmed blocks PBLK among the plurality of memory blocks 110 included in each of the nonvolatile memory devices 1100. In an embodiment, the free block information management section 1205 may manage the information about memory block indexes of free blocks FBLK or memory block indexes of programmed blocks PBLK among the plurality of memory blocks 110 included in each of the nonvolatile memory devices 1100. The free block information management section 1205 may include an embedded SRAM. In an embodiment, the free block information management section 1205 may include a DRAM.

The wear leveling information management section 1206 may manage information about wear leveling of the memory blocks 110A 110D included in each of the nonvolatile memory devices 1100A to 1100D. In other words, the wear leveling information management section 1206 may manage information indicating the level of wear leveling of each of the memory blocks 110 included in each of the nonvolatile memory devices 1100. In an embodiment, the wear leveling information management section 1206 may manage information about the number of program-erase cycles on each of the memory blocks 110 included in each of the nonvolatile memory devices 1100.

The garbage collection control section 1203 may be included in the processor 710 of FIG. 2. The garbage collection control section 1203 may control the nonvolatile memory devices 1100A to 1100D to perform a garbage collection operation based on information, which is stored in the valid page information management section 1204 and is about valid pages or invalid pages of each of the memory blocks 110 included in the super block (SBLK) 500, to secure an additional free block FBLK. For example, the garbage collection control section 1203 may preferentially select, as a victim block, a memory block 110 having the smallest number of valid pages among the memory blocks 110 included in the super blocks (SBLK) 500, and then perform a garbage collection operation on the selected memory block 110. Here, the garbage collection control section 1203 may copy data of valid pages included in the victim block to another super block 500 and perform an erase operation on the victim block. Thereafter, the free block information management section 1205 may manage the victim block, on which the erase operation has been performed, as a free block FBLK.

Furthermore, the garbage collection control section 1203 may control the nonvolatile memory devices 1100A to 1100D to perform a garbage collection operation based on information, which is stored in the free block information management section 1205 and is about whether each of the memory blocks 110 included in each of the nonvolatile memory devices 1100 is a free block FBLK or a programmed block PBLK, to secure an additional free block FBLK. For example, the garbage collection control section 1203 may preferentially select, as a victim block, a memory block 110 included in a nonvolatile memory device 1100 having the smallest number of free blocks FBLK among the nonvolatile memory devices 1100, and then perform a garbage collection operation on the selected memory block 110. Here, the garbage collection control section 1203 may copy data of valid pages included in the victim block to another super block 500 and perform an erase operation on the victim block. Thereafter, the free block information management section 1205 may manage the victim block, on which the erase operation has been performed, as a free block. In other words, the garbage collection control section 1203 may preferentially select, as a victim block, a memory block 110 included in a nonvolatile memory device 1100 having the smallest number of free blocks FBLK among the nonvolatile memory devices 1100, and then perform a garbage collection operation on the selected memory block 110, thus controlling the number of free blocks FBLK such that it is uniform between the nonvolatile memory devices 1100.

The garbage collection control section 1203 may control the nonvolatile memory devices 1100A to 1100D to perform a garbage collection operation based on information, which is stored in the wear leveling information management section 1206 and is about the wear-leveling level of the memory blocks 110A to 110D included in each of the nonvolatile memory devices 1100A to 1100D, to secure an additional free block FBLK. For example, the garbage collection control section 1203 may preferentially select, as a victim block, a memory block 110 that has the lowest wear-leveling level among the memory blocks 110 included in the nonvolatile memory devices 1100, and then perform a garbage collection operation on the selected memory block 110. Thereby, the wear-leveling levels of the memory blocks 110 included in the memory system 1000 may be managed to be uniform.

The garbage collection control section 1203 may control the nonvolatile memory devices 1100A to 1100D to perform a garbage collection operation based on at least two pieces of information, which are stored in the valid page information management section 1204 and are about valid pages or invalid pages of each of the memory blocks 110 included in the super blocks (SBLK) 500. Information, which is stored in the free block information management section 1205 and is about whether each of the memory blocks 110 included in each of the nonvolatile memory devices 1100 is a free block FBLK or a programmed block PBLK, and information, which is stored in the wear leveling information management section 1206 and is about the wear-leveling level of the memory blocks 110 included in each of the nonvolatile memory devices 1100. The above information is used to secure an additional free block FBLK.

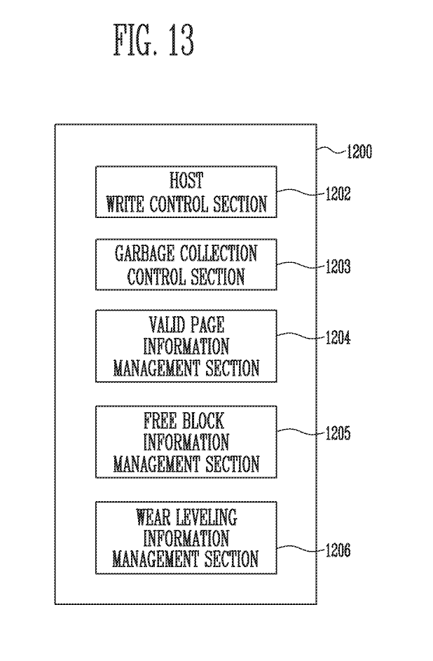

FIG. 14 is a diagram illustrating an example of a memory system 3000 including the memory controller 1200 shown in FIG. 13.

Referring to FIG. 14, the memory system 30000 may be embodied in a cellular phone, a smartphone, a tablet PC, a personal digital assistant (PDA) or a wireless communication device. The memory system 30000 may include a nonvolatile memory device 1100, and the memory controller 1200 configured to control the operation of the nonvolatile memory device 1100. The memory controller 1200 may control a data access operation, e.g., a program, erase, or read operation, of the nonvolatile memory device 1100 under control of a processor 3100.

Data programmed to the nonvolatile memory device 1100 may be output through a display 3200 under control of the memory controller 1200.

A radio transceiver 3300 may send and receive radio signals through an antenna ANT. For example, the radio transceiver 3300 may change a radio signal received through the antenna ANT into a signal that may be processed in the processor 3100. Therefore, the processor 3100 may process a signal output from the radio transceiver 3300 and transmit the processed signal to the memory controller 1200 or the display 3200. The memory controller 1200 may program a signal processed by the processor 3100 to the nonvolatile memory device 1100. Furthermore, the radio transceiver 3300 may change a signal output from the processor 3100 into a radio signal, and output the changed radio signal to an external device through the antenna ANT. An input device 3400 may be used to input a control signal for controlling the operation of the processor 3100 or data to be processed by the processor 3100. The input device 3400 may be embodied in a pointing device such as a touch pad and a computer mouse, a keypad or a keyboard. The processor 3100 may control the operation of the display 3200 such that data output from the memory controller 1200, data output from the radio transceiver 3300, or data output form the input device 3400 is output through the display 3200.

In an embodiment, the memory controller 1200 capable of controlling the operation of the nonvolatile memory device 1100 may be embodied as a part of the processor 3100 or a chip provided separately from the processor 3100. The memory controller 1200 may be embodied by the example of the memory controller shown in FIG. 13.

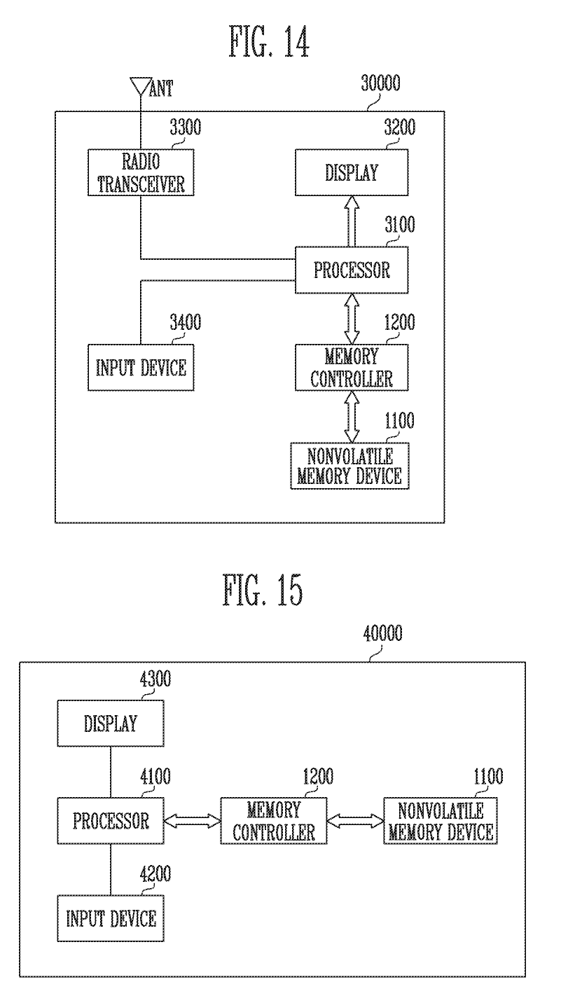

FIG. 15 is a diagram illustrating an example of a memory system 40000 including the memory controller 1200 shown in FIG. 13.

Referring to FIG. 15, the memory system 40000 may be embodied in a personal computer (PC), a tablet PC, a net-book, an e-reader, a personal digital assistant (PDA), a portable multimedia player (PMP), an MP3 player, or an MP4 player.

The memory system 40000 may include a nonvolatile memory device 1100, and a memory controller 1200 configured to control the data processing operation of the nonvolatile memory device 1100.

A processor 4100 may output data stored in the nonvolatile memory device 1100 through a display 4300, according to data inputted from an input device 4200. For example, the input device 4200 may be embodied in a pointing device such as a touch pad or a computer mouse, a keypad or a keyboard.

The processor 4100 may control the overall operation of the memory system 40000 and control the operation of the memory controller 1200. In an embodiment, the memory controller 1200 capable of controlling the operation of the nonvalotile memory device 1100 may be embodied as a part of the processor 4100 or a chip provided separately from the processor 4100. The memory controller 1200 may be embodied by the example of the memory controller shown in FIG. 13.

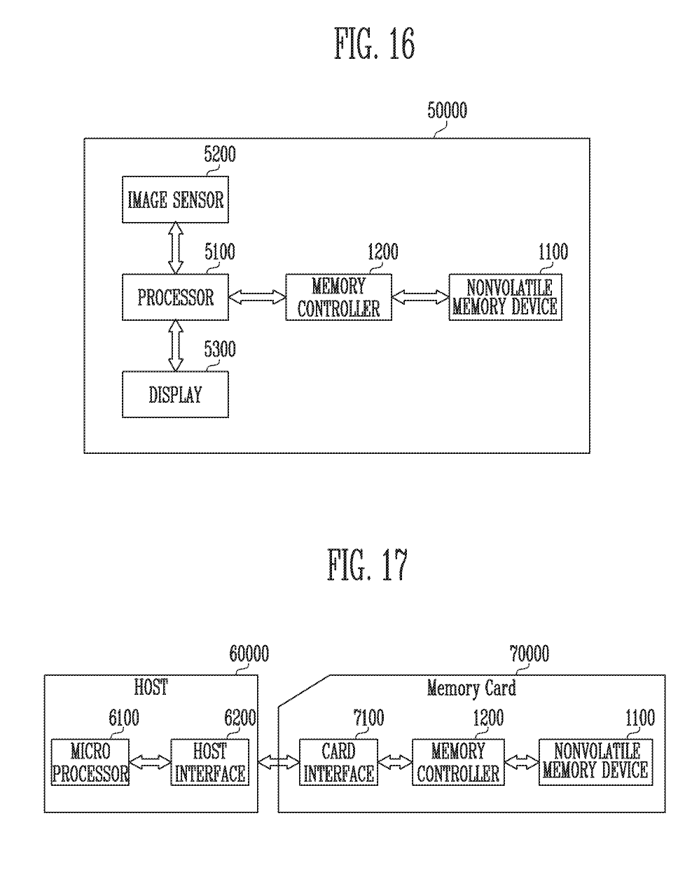

FIG. 16 is a diagram illustrating an example of a memory system 50000 including the memory controller 1200 shown in FIG. 13.

Referring to FIG. 16, the memory system 50000 may be embodied in an image processing device, e.g., a digital camera, a portable phone provided with a digital camera, a smartphone provided with a digital camera, or a tablet PC provided with a digital camera.

The memory system 50000 may include a nonvolatile memory device 1100, and a memory controller 1200 capable of controlling a data processing operation, e.g., a program, erase, or read operation, of the nonvolatile memory device 1100.

An image sensor 5200 of the memory system 50000 may convert an optical image into digital signals. The converted digital signals may be transmitted to a processor 5100 or the memory controller 1200. Under control of the processor 5100, the converted digital signals may be output through a display 5300 or stored in the nonvolatile memory device 1100 through the memory controller 1200. Data stored in the nonvolatile memory device 1100 may be output through the display 5300 under control of the processor 5100 or the memory controller 1200.

In an embodiment, the memory controller 1200 capable of controlling the operation of the nonvolatile memory device 1100 may be embodied as a part of the processor 5100 or a chip provided separately from the processor 5100. The memory controller 1200 may be embodied by the example of the memory controller shown in FIG. 13.

FIG. 17 is a diagram illustrating an example of a memory system 70000 including the memory controller 1200 shown in FIG. 13.

Referring to FIG. 17, the memory system 70000 may be embodied in a memory card or a smart card. The memory system 70000 may include a nonvolatile memory device 1100, a memory controller 1200, and a card interface 7100.

The memory controller 1200 may control data exchange between the nonvolatile memory device 1100 and the card interface 7100. In an embodiment, the card interface 7100 may be a secure digital (SD) card interface or a multi-media card (MMC) interface, but it is not limited thereto. The memory controller 1200 may be embodied by the example of the memory controller shown in FIG. 13.

The card interface 7100 may interface data exchange between a host 60000 and the memory controller 1200 according to a protocol of the host 60000. In an embodiment, the card interface 7100 may support a universal serial bus (USB) protocol, and an inter-chip (IC)-USB protocol. Here, the card interface may refer to hardware capable of supporting a protocol which is used by the host 60000, software installed in the hardware, or a signal transmission method.

When the memory system 70000 is connected to a host interface 6200 of the host 60000 such as a PC, a tablet PC, a digital camera, a digital audio player, a cellular phone, console video game hardware or a digital set-top box, the host interface 6200 may perform data communication with the nonvolatile memory device 1100 through the card interface 7100 and the memory controller 1200 under control of a microprocessor 6100.

In accordance with various embodiment of the present disclosure, in the operation of a memory system, a garbage collection operation is performed on a memory block basis, whereby the performance of the memory system may be improved.

Examples of embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A memory system comprising:
memory devices including memory blocks;
a super block configured of the memory blocks; and
a memory controller coupled to the memory devices,
wherein the memory controller comprises:
a host write control section configured to control the memory devices such that a program operation is performed in parallel on the memory blocks included in the super block;
a valid page information management section configured to store valid page information of each of the memory blocks; and
a garbage collection control section configured to select at least one of the memory blocks as a victim block based on the valid page information and perform a garbage collection operation on the victim block.

2. The memory system according to claim 1, wherein the memory devices form respective different ways.

3. The memory system according to claim 1, wherein the valid page information management section is configured to store the number of valid pages included in each of the memory blocks.

4. The memory system according to claim 3, wherein the garbage collection control section is configured to preferentially select, as the victim block, a memory block having the smallest number of valid pages among the memory blocks.

5. The memory system according to claim 1, wherein the garbage collection control section is configured to copy, in parallel, data stored in the valid pages included in the victim block to a plurality of memory blocks included in another super block.

6. The memory system according to claim 1, wherein the memory controller further comprises a free block information management section configured to store the number of free blocks included in each of the memory devices.

7. The memory system according to claim 6, wherein the garbage collection control section is configured to perform the garbage collection operation based on the number of free blocks.

8. The memory system according to claim 7, wherein the garbage collection control section is configured to preferentially select, as the victim block, the memory block included in a memory device having the smallest number of free blocks among the memory devices.

9. The memory system according to claim 8,
wherein the garbage collection control section is configured to perform an erase operation on the victim block, and
wherein the free block information management section is configured to manage, as the free block, the victim block on which the erase operation is performed.

10. The memory system according to claim 1,
wherein the memory controller further comprises a wear leveling information management section,
wherein the wear leveling information management section is configured to store information indicating wear-leveling levels of the memory blocks, and
wherein the garbage collection control section is configured to perform the garbage collection operation based on the information indicating the wear-leveling levels.

11. The memory system according to claim 1, wherein the memory block is a unit of an erase operation.

12. A method of operating a memory system, comprising:
selecting a victim block among erase unit blocks included in a first super block;
copying data stored in valid pages included in the selected victim block to a second super block; and
performing an erase operation on the victim block on which the copying has been performed,
wherein the selecting of the victim block is performed based on the number of valid pages of each of the erase unit blocks.

13. The method according to claim 12, further comprising:
receiving program data from a host;
generating the first super block by selecting the erase unit blocks from a plurality of memory devices forming different ways; and
programming the program data in parallel to the erase unit blocks included in the first super block.

14. The method according to claim 12, wherein an erase unit block having the smallest number of valid pages among the erase unit blocks is preferentially selected as the victim block.

15. The method according to claim 12, wherein an erase unit block having a lowest wear-leveling level among the erase unit blocks is preferentially selected as the victim block.

16. The method according to claim 12, wherein each of the erase unit blocks is formed of some memory cells included in a memory block.

17. A method of operating a memory system, comprising:
selecting N, where N is a natural number of 2 or more, victim blocks among memory blocks included in super blocks; and
performing a garbage collection operation on the selected victim blocks,
wherein each of the super blocks includes N memory blocks among the memory blocks,
wherein the N memory blocks are respectively included in N memory devices forming different ways, and
wherein the selecting of the victim blocks is performed based on the number of free blocks included in each of the N memory devices.

18. The method according to claim 17, further comprising:
receiving program data from a host; and
programming the program data in parallel to the N memory blocks included in any one of the super blocks.

19. The method according to claim 17, wherein the selecting of the victim blocks is performed based on the number of valid pages included in each of the memory blocks.

20. The method according to claim 17, wherein a memory block having the smallest number of valid pages among the memory blocks is preferentially selected as the victim block.
